(19) United States
(12) Patent Application Publication
(10) Pub. No.: US 2011/0017318 A1
(43) Pub. Date: Jan. 27, 2011

(54) Fluid Filling and/or Extracting Connector and Assembly Comprising a Connector and a Tap

(75) Inventor: Philippe Pisot, L'Isle Adam (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Expoitation Des Procedes Georges Claude, Paris (FR)

(21) Appl. No.: 12/934,345

(22) PCT Filed: Mar. 20, 2009
(86) PCT No.: PCT/FR2009/050477

§ 371 Date: Sep. 24, 2010

(30) Foreign Application Priority Data
Mar. 26, 2008 (FR) 0851930

(51) Int. Cl. B67D 3/04; F16L 55/00

(52) U.S. Cl. 137/317; 285/80

(57) ABSTRACT

Pressurized fluid filling and/or extracting connector, particularly for a pressurized gas, said connector being designed to be selectively connected to a fluid receiving device such as a tap of a pressurized tank, said connector comprising a fluid supply line, at least one male and/or female attachment part designed to engage selectively by attaching to at least one mating female and/or male attachment port on the receiving device, the connector comprising a pressure-sensitive lock bolt in the fluid supply line, and being characterized in that in its first and second positions the lock bolt is so shaped as to lock or release the attachment part via at least one intermediate locking part separate from the lock bolt, the intermediate locking part; being selectively movable between a locked position and an unlocked position of the attachment part or parts, and in that the lock bolt includes at least one member such as a pin movable in relation to the intermediate locking part, the movable member forming a retractable stop for the intermediate locking part depending on the pressure of the fluid in the supply line.

The present invention relates to a connector for filling and/or extracting pressurized fluid, to a connector and tap assembly and to the use thereof.

The invention more particularly relates to a coupling or a connector for filling and/or extracting pressurized fluid, particularly pressurized gas, which is intended to be connected selectively to a fluid receiving device such as a tap of a pressurized tank, said connector comprising a fluid supply circuit, at least one male and/or female attachment element designed to engage selectively for the purposes of attachment with at least one mating female and/or male attachment port of the receiving device, the connector comprising a lock sensitive to the pressure in the fluid supply circuit, said lock being able to move automatically under the action of the pressure in the fluid supply circuit between a first position in which the attachment element is blocked when the pressure in the fluid supply circuit is above a set threshold pressure and a second position in which the attachment element is unblocked when the pressure in the fluid supply circuit is below the threshold pressure, in its blocked first position, the lock being configured to prevent the connector and the attachment port from being detached from one another when the connector is already connected to a fitting, in its unblocked second position, the lock being configured to allow the connector and the attachment fitting to be detached from or secured to one another.

In applications to gas cylinders fitted with standard taps, a manual isolation control is (hand wheel or lever) is normally provided on the tap, and a standardized gas inlet/outlet port is also provided, this being defined according to the legislation currently in force. This inlet/outlet port is provided with a male or female right-hand or left-hand thread so that it can be coupled to a filling fitting determined according to the nature of the gas (fuel or oxidant for example).

The filling fittings used for filling these cylinders are mostly couplings or connectors that have to be screwed manually onto the port of the tap. Coupling is therefore not a speedy process and there is no special-purpose means to prevent uncoupling under pressure (apart from the very high unscrewing torque required on account of the pressure of the gas). In addition, the resultant loadings from the pressure of the gas highly stress the connection between the fitting and the port.

Known filling fittings have jaws with toothed sectors that mimic the screw thread on the inlet/outlet ports to improve the speed of coupling. Certain fittings have mechanical means that prevent the fitting and the port from becoming uncoupled when the connection has not been secured (for example a band has to be fitted around the bonnet of the cylinder). However, there are still risks involved if unlocking should occur when the gas pressure is still present in the fitting.

Cylinders fitted with taps that have in-built regulating valves are generally equipped with an inlet port and with an outlet port which are separate. For legislatory reasons and also with a view to harmonization and standardization, the inlet ports are identical to the inlet/outlet ports of standard taps. For this reason, the filling fittings are therefore the same as in the preceding application.

One storage solution is to provide tanks or volumes that form an integral part of the application such as the tanks carried permanently on board vehicles in which filling is performed via a rapid connection, the profile of which is standardized. In these connections, the resultant loadings from the pressure directly stress the mechanical union between the connection and the filling fitting. One known solution provides a filling fitting fitted with a device that prevents uncoupling under pressure and which is embodied by a safety button that has to be pressed in order to be able to disconnect the fitting (double action).

Document DE 1 025 688 describes a hose for supplying pressurized air, the connection end of which comprises attachment half-cuffs intended to collaborate with a complementary receiving system. The connection end further comprises a moving piston subject to the pressure in the supply hose. When the hose is under pressure, the rod of the piston protrudes at the attachment half-cuffs to form an end stop that interferes with the cuffs to prevent the half-cuffs from being attached (or to prevent detachment when the half-cuffs are already connected).

The piston can be retracted when no longer subjected to sufficient gas pressure.

This solution improves the safety of the connection but, in certain situations, it is nevertheless possible for the user to make a dangerous and incorrect connection.

These solutions are not, however, satisfactory.

The invention relates in particular to how to make the method of filling a high pressure gas tank safer by implementing mechanical and/or pneumatic solutions that are incorporated particularly into the filling line (filling fitting) connection interface.

One object of the present invention is to remedy all or some of the abovementioned disadvantages of the prior art.

To this end, the connection according to the invention, in other respects in accordance with the generic definition thereof given in the above preamble, is essentially characterized in that in its first and second positions, the lock is configured to block or unblock the attachment element via at least one intermediate locking element distinct from the lock, the intermediate locking element being selectively removable between a position in which the at least one attachment element is locked and a position in which the latter is not locked, and in that the lock comprises at least one moving part such as a peg able to move with respect to the intermediate locking element, the moving part forming a retractable end stop for the locking element according to the pressure of the fluid in the supply circuit.

According to the invention, the connection has a first level of automatic locking via the intermediate locking element that acts selectively on the attachment element or elements and a second level of locking via the pressure-sensitive lock.

The pressure-sensitive lock acts selectively on the intermediate locking element.

The invention thus allows the user to be given an indication that he has made a correct connection via the intermediate locking element. The invention additionally then makes the connection safe and secure in a correct position, via the lock, only when the system is under pressure.

Thus, the locking element acts selectively only on the attachment elements while the pressure-sensitive lock acts selectively only on the locking element (and not on the attachment elements directly). This provides two levels of safety that the user can readily identify.

Moreover, some embodiments of the invention may include one or more of the following features:
in its blocked first position, the lock is configured to position the attachment element in a configuration that prevents the connector from being connected to an attachment port when the connector has not yet been connected to said port,
in its first and second positions, the lock is configured to block or unblock the attachment element via at least one intermediate locking element,
the locking element is able to move selectively between a locked first position and an unlocked second position, in the locked first position the locking element locking the attachment element in the attached position to prevent the connector and the attachment port from being detached from one another when the connector is already connected to the port and, possibly, to prevent the connector and the attachment port from being connected when the connector is not yet connected to the port, in the unlocked second position the locking element not locking the attachment element, thus allowing the connector and the attachment port to be detached from or secured to one another, and in that, in its blocked first position, the lock is configured to block the locking element in its locked first position and prevent it from moving into its unlocked second position,
in its unblocked second position, the lock is configured to not block the locking element and allow the latter to move from its locked first position into its unlocked second position,
the locking element is urged automatically into its locked first position by a return element, the locking element being movable by hand and/or mechanically between its first and second positions,
the lock comprises at least one moving peg that forms a retractable end stop according to the pressure of the fluid in the supply circuit,
the peg forms a retractable end stop for the locking element and/or for the attachment element,
the lock comprises a moving piston subject to the antagonistic forces of, on the one hand, the pressure of the fluid in the supply circuit and, on the other hand, a return member, the piston urging the moving peg into its end-stop position or into its retracted position,
the attachment element comprises grooves and/or pins of the bayonet type intended to collaborate with bayonet-type pins and/or grooves,
the end of the spindle is closed by a fluidtight shut-off member opened when the filling fitting is being connected to a port,
the attachment element or elements are formed on a connection portion, the locking element comprises a moving body capable of translational and/or of rotational movement relative to the connection portion,
the locking element comprises a moving portion able selectively to block the pins or bayonets in the grooves by acting as an end stop, in particular by closing the exits of the grooves,
the distribution spindle carries the pressurized fluid in its internal duct as far as at least one outlet situated at one end, said duct forming at least part of a circuit, a moving shut-off member selectively covering the end of the spindle,
the shut-off member comprises two sealing pairs each comprising an O-ring seal and an anti-extrusion ring which are positioned on each side of the outlet orifices of the spindle, to isolate the circuit of the fitting with respect to the outside,
the shut-off member is urged into the position in which the orifices are sealed closed by a return member and can be moved into the position in which the orifices are open by the thrust of contact upon mechanical connection of the filling fitting to a port,
the receiving device or tap is connected to a pressurized-gas tank containing hydrogen,
the connector comprises a connection zone for a gas supply hose,
the hand grip is free to turn about the support spindle so as to prevent a twisting torque from being transmitted to the hose connected to the rear of the fitting.

The invention may also relate to an assembly comprising a tap for pressurized fluid, particularly for pressurized gas, and a system for filling/extracting fluid via the tap, the tap being provided with a filling fitting, the filling/extraction system comprising a connector intended to be connected selectively to a filling port of the tap, the connector being a connector in accordance with any one of the features below or hereafter.

According to other possible particular features:
the connector comprises a spindle forming a valve push rod intended to open a valve and/or a flap contained deep within a housing of the body of the tap, the spindle having an internal duct carrying the pressurized fluid as far as an outlet situated at one end, said duct forming at least part of the fluid supply circuit, the housing in the body of the tap accommodating the end of the spindle comprising a sealing system involving two sets of seals intended to be positioned respectively one on each side of the fluid outlet around the spindle when the connector is connected to the tap,
the two sets of seals are of the O-ring type and have substantially identical diameters so as to equalize the pressures across the spindle, said seals preferably each being associated with an anti-extrusion ring.

The invention may also relate to any alternative device or method comprising any combination of the features hereinabove or hereinbelow.

The invention thus makes it possible to prevent the filling fitting from being connected or disconnected when the filling fitting is under pressure.

The invention may also provide (in addition or separately) a way of canceling the forces due to the pressure which have a tendency to stress the mechanical union between the connection interface of the filling fitting and the filling port of the tank that is to be filled.

The invention has the notable advantage of making the manual actions needed to perform an operation of filling high-pressure gas tanks intuitive and unambiguous in order to improve safety and productivity in filling centers.

Thus, the invention proposes a system for preventing the filling fitting from being connected and/or disconnected under pressure, in which the control of the prevention system is preferably separate from the pressure detecting element. The result of this is that the force needed to actuate the unlocking control is constant irrespective of the pressure, provided that this pressure meets the locking requirement.

Other specifics and advantages will become apparent from reading the following description which is given with reference to the figures in which:

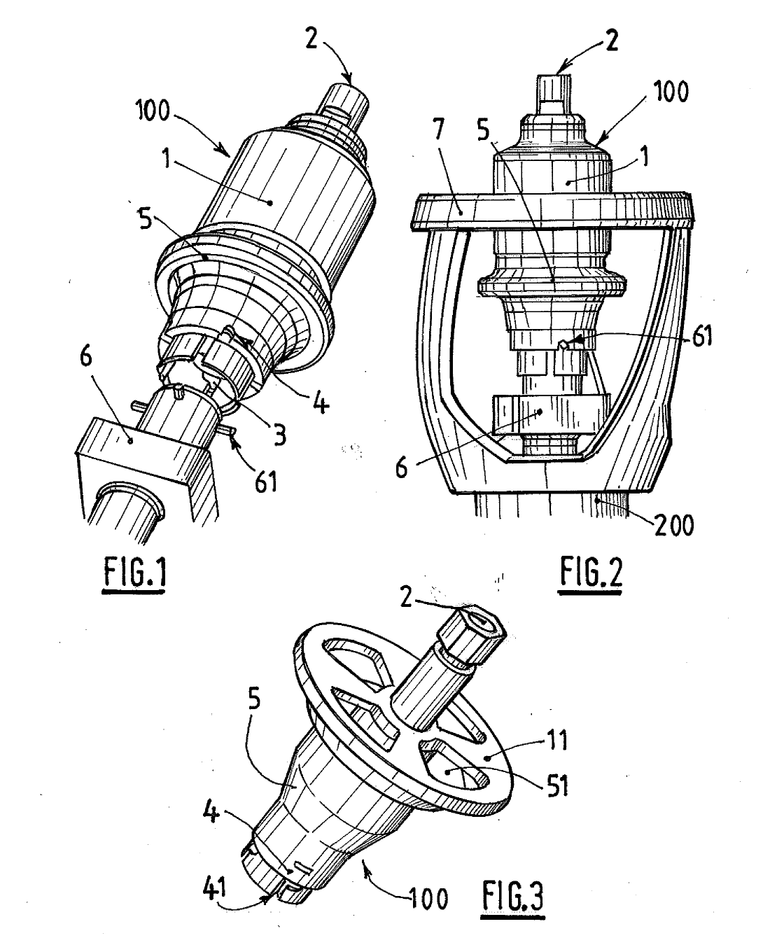

FIG. 1 depicts an external view in isometric perspective of one possible embodiment of a filling fitting for a gas tank according to the invention, in the position in which a tap is disconnected,

FIG. 2 depicts the filling fitting of FIG. 1 in the position in which it is connected to a tap of a cylinder fitted with a protective bonnet,

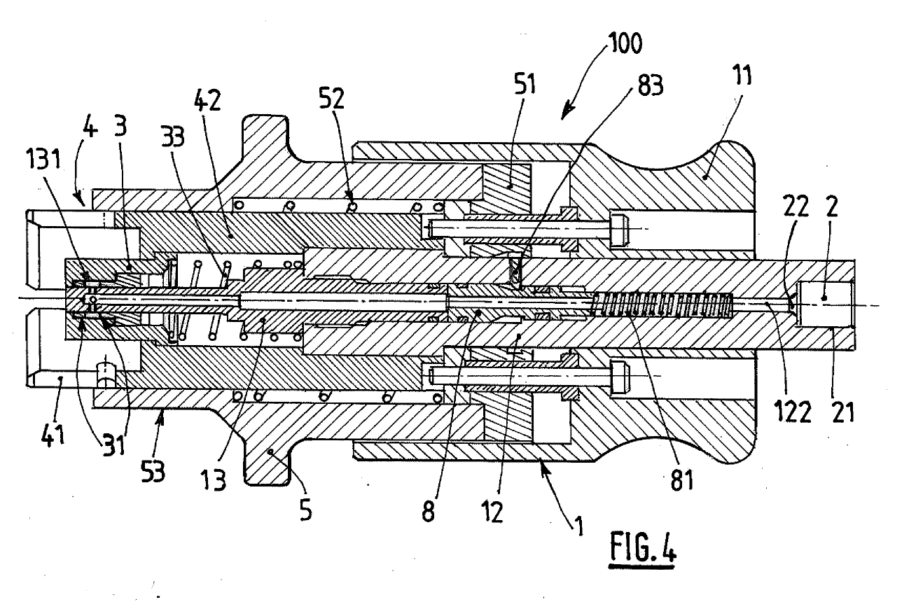

FIG. 3 is an external and isometric perspective view of one possible alternative embodiment of the filling fitting of FIGS. 1 and 2,

FIG. 4 is a view in longitudinal section of the filling fitting of FIGS. 1 and 2 in the position known as the rest position (no gas pressure),

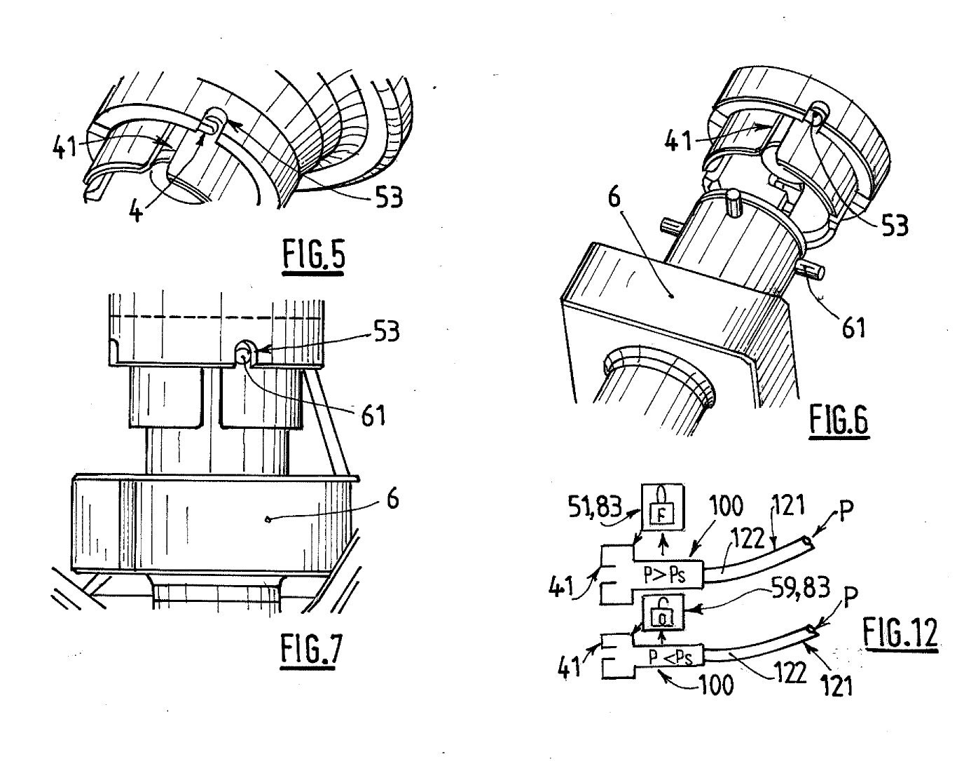

FIGS. 5, 6 and 7 depict external detail views of the system for connecting the filling fitting of FIGS. 1 and 2,

FIG. 8 is a view in longitudinal section of an internal detail of the system for connecting the filling fitting of FIGS. 2 and 7,

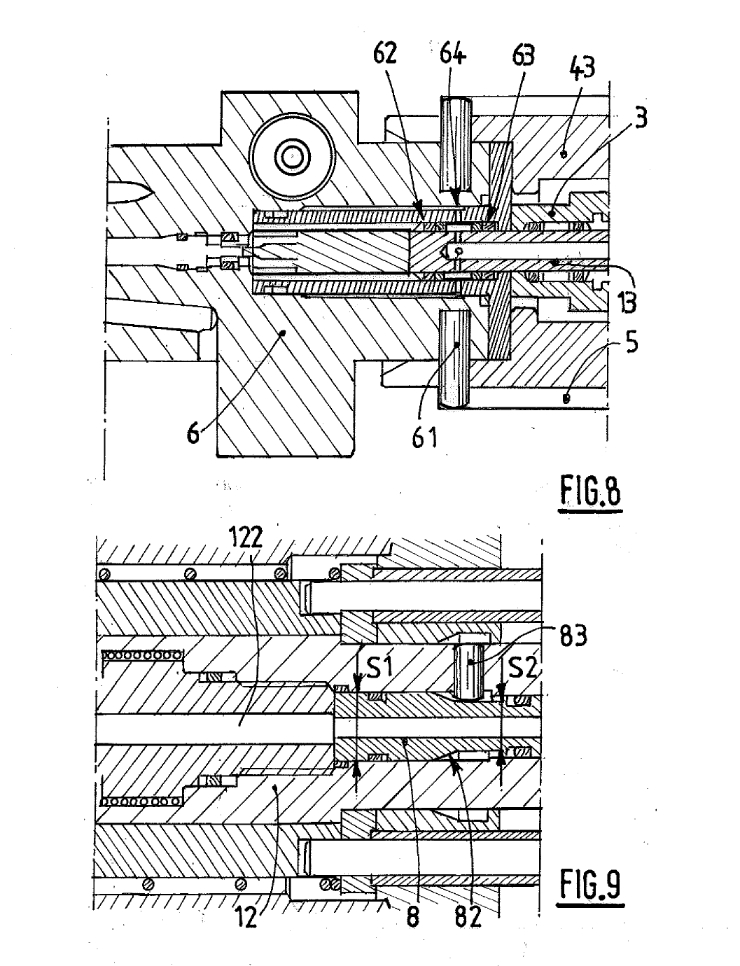

FIG. 9 is a view in longitudinal section of an internal detail of the locking system of FIGS. 2 and 7 in the unblocked configuration,

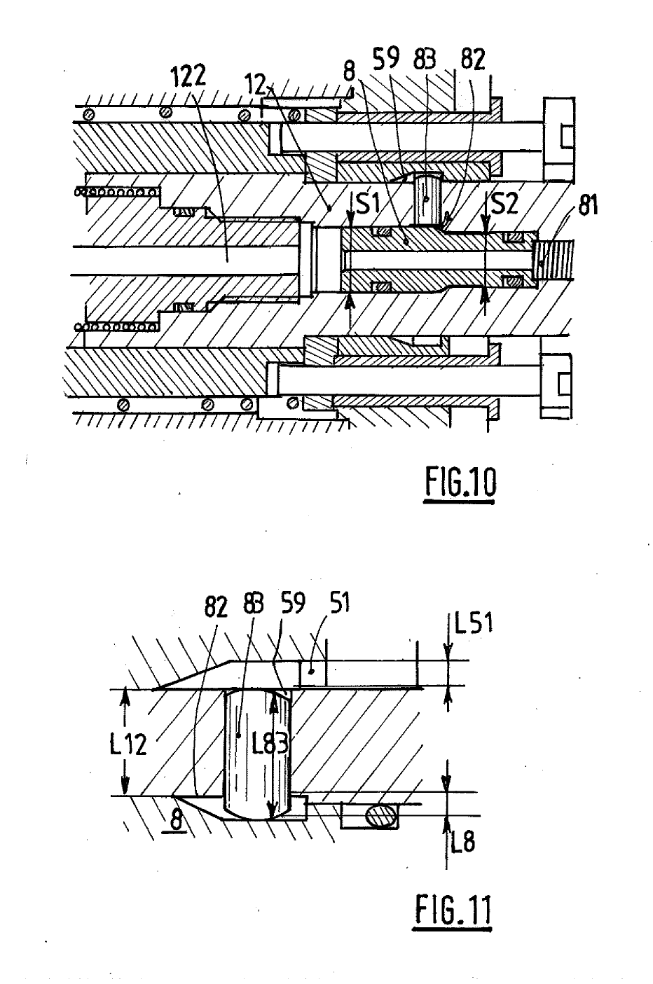

FIG. 10 is a view similar to FIG. 9 but in the blocked configuration,

FIG. 11 is an enlargement of a detail of FIG. 9,

FIG. 12 depicts schematic and simplified views illustrating one principle of operation of the filling fitting according to the invention (locked at the top and unlocked at the bottom).

FIG. 2 depicts a filling fitting 100 for a gas cylinder 200 fitted with a tap 6 protected by a bonnet 7. The filling fitting 100 may comprise a cylindrical body 1, one of the ends of which comprises a connector 2 allowing said fitting 100 to be coupled fluidtightly to a hose 121 of a gas filling line (cf. FIG. 12).

The other end of the fitting 100 comprises a connection interface housing a fluid distribution spindle 13. The connection interface comprises a mechanical attachment system 4 allowing fluidtight coupling to the port of the tap 6 of the tank that is to be filled.

In the nonlimiting example described here, the attachment system 4 comprises cranked grooves 41 formed on the end of the fitting 100 and intended to collaborate with radial pins 61 formed on one end of the tap 6. The assembly forms a bayonet-type fixing system. For further details, reference may be made to document WO2007048955. However, this embodiment of the attachment system is neither exclusive nor limiting and can be replaced or supplemented by other equivalent connection systems such as screw-fastening, clipping, clamping, etc.

The bayonet connection 41-61 can be locked by a moving part 5. For example, the attachment of the pins in the grooves 41 can be locked/unlocked in particular by a ring 5 of tubular overall shape mounted with the facility for translational movement coaxially with respect to the body 1 of the fitting.

The locking/unlocking ring 5 is urged by an internal spring 52 into a forward position in which it closes the open ends (exits) of the grooves 41. This prevents the stubs 61 from leaving the corresponding grooves 41 (locking the fitting on the tap 6). The ring 5 can be pushed back manually and/or mechanically (against the action of the spring 52) to free the openings (exits) of the grooves 41 (unlocking the fitting from the tap 6).

The locked position can be blocked by a lock system 51, 83, 8 described in greater detail hereinafter.

With reference to FIG. 4, the filling fitting is in the position known as the rest position (no pressurized gas in the fitting). A connector 2, for example a female connector, is provided at the rear end of the fitting 100. The connector 2 is formed for example in a tubular support spindle 12. This connector 2 for a hose may comprise a tapped thread 21 and a female sealing cone 22 providing a fluidtight connection between the filling fitting 100 and a hose of a high-pressure filling line (not depicted).

The body 1 of the filling fitting 100 comprises an external hand grip 11. The hand grip 11 is free to turn about the support spindle 12 in order to prevent a twisting torque from being transmitted to the hose 121 which is connected to the rear of the fitting. For example, the hand grip 11 rotates as one with a lock collar 51 described in greater detail hereinafter (the lock collar 51 may, however, slide with respect to the hand grip 11 when not blocked as described hereinafter). The support spindle 12 in its center houses a tubular distribution spindle 13 that has an internal duct able to carry the pressurized fluid.

A fluidtight shut-off member 3 is mounted on the end in the connector 42. More specifically, the shut-off member 3 is slidably mounted on the forward end of the distribution spindle 13.

When the fitting 100 is not connected (see FIG. 4), the shut-off member 3 covers the end of the distribution spindle 13. The shut-off member 3 for example comprises two sealing pairs 31 each comprising an O-ring seal and an anti-extrusion ring which are positioned on each side of the distribution orifices 131 of the spindle 13. These two sealing pairs 31 isolate the circuit 122 of the filling fitting 100 with respect to the outside. When the fitting 100 is connected to a receiving tap, the shut-off member 3 is, for example, pushed back by contact with a mating surface of the port of the tap 6. More specifically, the shut-off member 3 can slide around the distribution spindle 13 and be pushed back into a position in which the orifices 131 are uncovered. A return spring 33 preferably by default urges the shut-off member forward into the position in which the orifices 131 are shut off (automatic closure in the event of disconnection).

The moving locking/unlocking ring 5 slides around a connector 42 mounted on the support spindle 12. The return spring 52 tends always to return the moving spring 5 to the locked position (toward the forward end of the fitting 100, i.e. to the left in FIG. 4).

The L-shaped attachment grooves 41 are situated, for example, on the forward end of the connector 42 that forms the mechanical union element 4.

When the filling fitting 100 is being connected to a tap 6 fitted with mating pins or bayonets 61 (cf. FIGS. 1, 2, 5, 6, 7), the fitting 100 is offered up and moved into position in such a way that the entrances/exits of the L-shaped grooves 41 correspond to said pins 61. A translational movement of the filling fitting 100, followed by a rotational movement thereof, causes the moving ring 5 to retreat once the bayonets 61 have come into contact with this locking ring 5. When the pins 61 reach the end of the grooves 41, the locking ring 5 returns automatically to its locked position (spring 52) in which it locks the bayonets 61 in the housings 53 (cf. FIG. 7).

During this operation, the end of the distribution spindle 13 enters the body of the tap 6 via an opening (cf. FIGS. 8 and 9), thereby freeing the shut-off member 3.

The forward end of the distribution spindle 13 becomes lodged fluidtightly inside the tap 6, positioning itself between two sealing pairs 62 and 63 each comprising an O-ring seal and an anti-extrusion ring. The two sealing pairs 62 and 63 are arranged concentrically at the end of the spindle 13 and guide the fluid emerging radially from the spindle 13 through orifices 64 (cf. FIG. 8).

The two sealing pairs 62 and 63 preferably have the same diameters so that the forces due to the pressure of the gas on the spindle are equalized. Thus, the mechanical stresses on the connection between the fitting 100 and the tap 6 are low.

The support spindle 12 also houses a tubular piston 8 which is urged forward by a spring 81. The piston 8 is, for example, of the differential type and has two ends of different cross sections S1 and S2 dimensioned to generate on the piston 8 a force that opposes the action of the spring 81 when the pressurized gas arrives via the rear connector 2 (cf. FIGS. 9 and 10).

In the configuration of FIG. 9, the piston 8 does not have the pressure of the gas acting upon it (unblocked configuration).

During the filling phase, as soon as the pressure in the fitting 100 rises above a threshold pressure Ps, disconnection is rendered impossible.

Specifically what happens is that beyond a set threshold pressure Ps, the force F of the spring is exceeded by the force of the pressurized gas (Ps=F/(S1−S2)).

Thus, if the pressure in the filling fitting 100 is above the threshold Ps, the piston 8 moves backward (cf. FIG. 10, blocked configuration), exceeding the force F of the spring 81.

The piston 8 has an inclined plane 82 or some other appropriate cam surface in contact with one or more peg(s) 83. The pegs 83 are mounted such that they can move in a slot formed in the support spindle 12. The slots housing the pegs 83 open into a keyway-type feature 59 facing a surface of a lock collar 51. The lock collar 51 is mounted around the support spindle 12 and moves as one with the locking ring 5 in translational movement.

When the piston 8 and its inclined plane 82 are moved to the right under the action of the pressure of the gas, the inclined plane 82, in contact with the pegs 83, pushes these pegs back into the keyway-type feature 59 of the lock collar 51. The pegs 83 have a length sized to allow them to protrude into the keyway-type feature 59 when the piston 8 has reached its extreme position (cf. FIG. 10). The length L of a peg 83 can be defined as follows:

L<(L12=wall thickness of the support spindle 12+L51=space between the support spindle 12 and the lock collar 51),

L>L12=wall thickness of the support spindle 12, and

L<(L12=wall thickness of the support spindle 12+L8=height of inclined plane).

When the pegs 83 protrude into the keyway-type feature 59 of the lock collar 51 they form end stops preventing any translational movement of the lock collar 51 along the spindle 12. What happens is that the pegs 83 protruding into the keyway-type feature 59 form a mechanical connection of the key and keyway type between the fixed support spindle 12 and the moving lock collar 51. The lock collar 51 thus blocks the translational movement of the moving ring 5 (the lock collar 51 moves as one in translational movement with the locking ring 5).

In this way, the bayonets 61 of the tap 6 can no longer be freed from their housings 53. The uncoupling of the filling fitting 100 with respect to the tap 6 is rendered impossible. The uncoupling of the filling fitting 100 with respect to the tap 6 will not become possible again until the pressure in the filling fitting 100 drops below the threshold pressure Ps (the reverse process to the one described above) cf. FIG. 12.

After unblocking (P<Ps), the unlocking of the fitting 100 can be obtained by pushing the ring 5 manually or mechanically backward to allow the bayonet attachment (or equivalent) to be undone.

In a filling center, a filling line may be fitted with several filling fittings 100. Thus, during a filling cycle, it is possible that some of these fittings 100 might not be connected to a tap 6. In such instances, the filling pressure arrives at the filling fitting 100 which is shut off and fluidtight (shut-off member 3).

According to the same principle as described previously, when the filling fitting 100 is not connected to a tap 6 but is subjected to a pressure above the threshold Ps, the locking system 5 is blocked in the locked position which prevents said filling fitting 100 from being coupled to a tap 6.

FIG. 3 shows one possible alternative form of the filling fitting 100 of FIGS. 1 and 2 in which the fitting 100 body is provided with a fixed hand wheel 11 used for holding to make it easier for the operator to operate the fitting 100. In addition, the control used to unlock said filling fitting is embodied by a moving hand wheel 51 located coaxially and set back with respect to the fixed hand wheel 11 used for holding.

The invention also allows the resultant forces from the pressure of the gas to be equalized, and this has the effect of limiting the filling fitting repulsion forces and therefore the mechanical stresses on the union between the connector 6 and the filling fitting 100.

1-8. (canceled)

9. An assembly comprising:
a tap for pressurized gas, the tap being provided with a housing, a valve and/or a flap contained deep within the housing, a filling port, and a filling fitting; and
a system for filling/extracting the pressurized gas via the tap, the filling/extraction system comprising a connector adapted to be selectively connected to the tap filling port, wherein:
the connector comprises a moving spindle forming a valve push rod intended to open the valve and/or flap;
the spindle has an outlet situated at one end thereof and an internal duct adapted to carry the pressurized gas as far as the spindle outlet, said duct forming at least part of a fluid supply circuit;
the tap housing is configured to accommodate the end of the spindle having the spindle outlet;
the tap housing comprises a sealing system including two sets of seals each one of which is positioned on a respective side of the spindle outlet around the spindle when the connector is connected to the tap.

10. The assembly of claim 9, wherein the two sets of seals are of the O-ring type and have identical diameters so as to equalize a pressure of the pressurized gas across the spindle.

11. The assembly of claim 10, wherein each of the sets of seals is operably associated with a respective anti-extrusion ring.

12. The assembly of claim 9, wherein the end of the spindle having a spindle outlet is closed by a moving fluidtight shut-off member which is opened when the filling fitting is being connected to a port.

13. The assembly of claim 12, wherein the shut-off member comprises two sealing pairs each one of which comprises an O-ring seal and an anti-extrusion ring positioned on a respective side of the spindle outlet in order to isolate the fitting circuit with respect to the outside.

14. The assembly of claim 9, wherein:
the connector comprises the fluid supply circuit, at least one male and/or female attachment element adapted to selectively engage for the purposes of attachment with at least one mating female and/or male attachment port of a receiving device; and the connector comprising a lock sensitive to the pressure in the fluid supply circuit;
said lock being able to move automatically under the action of pressure in the fluid supply circuit between a first position in which the attachment element is blocked when the pressure in the fluid supply circuit is above a set threshold pressure and a second position in which the attachment element is unblocked when the pressure in the fluid supply circuit is below the threshold pressure;
in its blocked first position, the lock being configured to prevent the connector and the attachment port from being detached from one another when the connector is already connected to a fitting;
in its unblocked second position, the lock being configured to allow the connector and the attachment fitting to be detached from or secured to one another;
in its first and second positions, the lock is configured to block or unblock the attachment element via at least one intermediate locking element distinct from the lock, the intermediate locking element being selectively removable between a position in which the at least one attachment element is locked and a position in which the latter is not locked, and;
the lock comprises at least one moving part able to move with respect to the intermediate locking element, the moving part forming a retractable end stop for the locking element according to a pressure of the pressurized gas in the supply circuit.

15. The assembly of claim 14, wherein the attachment element comprises grooves and/or pins of the bayonet type adapted to collaborate with bayonet-type pins and/or grooves.

16. The assembly of claim 15, wherein the locking element comprises a moving portion selectively able to block the pins or bayonets in the grooves by acting as an end stop closing the exits of the grooves.

17. The assembly of claim 14, wherein the moving part of the lock is a peg.
